(19) United States
(12) Patent Application Publication
(10) Pub. No.: US 2018/0176708 A1
(43) Pub. Date: Jun. 21, 2018

(54) OUTPUT CONTROL DEVICE, CONTENT STORAGE DEVICE, OUTPUT CONTROL METHOD AND NON-TRANSITORY STORAGE MEDIUM

(71) Applicant: CASIO COMPUTER CO., LTD., Tokyo (JP)

(72) Inventor: Nobuteru Takahashi, Akishima-shi (JP)

(21) Appl. No.: 15/799,721

(22) Filed: Oct. 31, 2017

(30) Foreign Application Priority Data
Dec. 20, 2016 (JP) 2016-246433

(51) Int. Cl. H04S 7/00; G06K 9/00; H04N 5/232

(52) U.S. Cl. CPC H04S 7/303; G06K 9/00228; H04N 5/23238; G06K 9/00369

(57) ABSTRACT

An output control device including a hardware processor, wherein the hardware processor is configured to: acquire a height of a viewer who watches a content; and cause an output unit to output a sound of the content corresponding to the acquired height.

This application is based upon and claims the benefit of priority from the prior Japanese Patent Application No. 2016-246433, filed on Dec. 20, 2016, the entire contents of which are incorporated herein by reference.

### BACKGROUND OF THE INVENTION

### 1. Field of the Invention

The present invention relates to an output control device, a content storage device, an output control method and a non-transitory storage medium.

### 2. Description of Related Art

Devices capable of panoramic projection have been conventionally known (for example, see Japanese Unexamined Patent Application Publication No. 2010-536061).

However, in the conventional techniques of panoramic projection, same sound is output regardless of the height at which a viewer watches the contents. Thus, realistic sensation has not been acquired.

### SUMMARY OF THE INVENTION

An object of the present invention is to enable output of sound with realistic sensation corresponding to the height of a viewer.

In order to solve the above object, according to an aspect of the present invention, there is provided an output control device including a hardware processor, wherein the hardware processor is configured to: acquire a height of a viewer who watches a content; and cause an output unit to output a sound of the content corresponding to the acquired height.

According to an aspect of the present invention, it is possible to output sound with realistic sensation corresponding to the height of a viewer.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 is a view showing the entire configuration example of a content output system in an embodiment;

FIG. 2 is a block view showing a functional configuration of a content storage device in FIG. 1;

FIG. 3 is a view showing a setting state of a content output device in the embodiment;

FIG. 4 is an image view showing a state of projecting contents by the content output device in FIG. 1; and

FIG. 5 is a block diagram showing a functional configuration of the content output device in FIG. 1;

FIG. 6 is a view for explaining attachment of microphones at the time of photographing using the content storage device in FIG. 1; and

FIG. 7 is a flowchart showing output control processing executed by a control unit in FIG. 5.

### DETAILED DESCRIPTION OF THE PREFERRED EMBODIMENT

Hereinafter, embodiments of the present invention will be described in detail with reference to the drawings. The present invention is not limited to the illustrated examples.

### [Configuration of Content Output System]

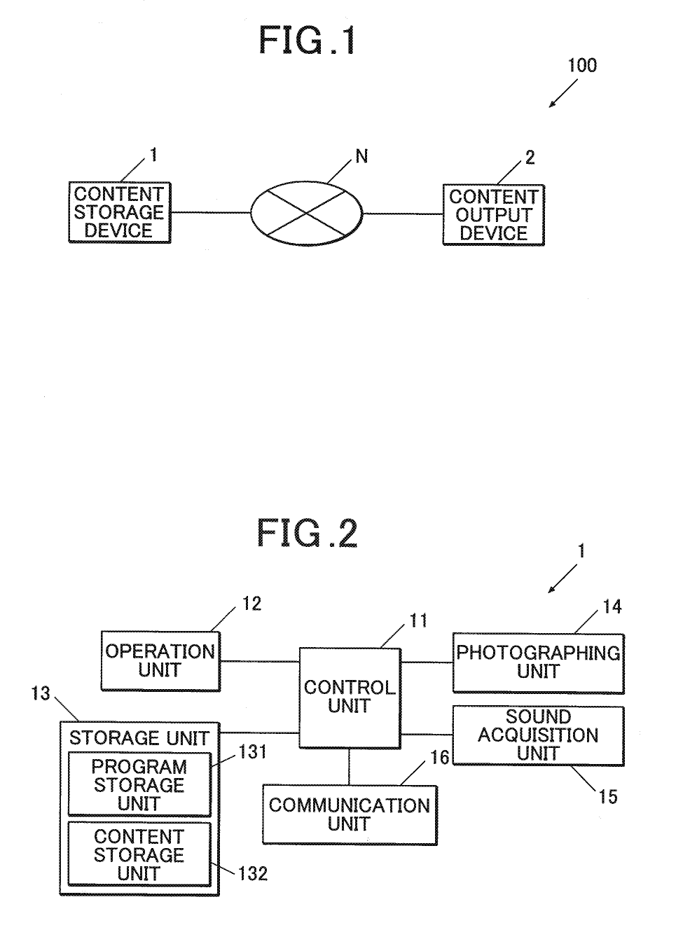

FIG. 1 is a view showing the entire configuration of a content output system 100 in an embodiment of the present invention. The content output system 100 is configured by including a content storage device 1 and a content output device 2 as shown in FIG. 1.

The content storage device 1 and the content output device 2 can be communicably connected to each other via a communication network N such as a LAN (Local Area Network) and a WAN (Wide Area Network).

### [Configuration of Content Storage Device 1]

The content storage device 1 acquires and stores content data by performing moving image photographing.

FIG. 2 is a block diagram showing a main control configuration of the content storage device 1.

As shown in FIG. 2, the content storage device 1 is configured by including a control unit 11, an operation unit 12, a storage unit 13, a photographing unit 14, a sound acquisition unit 15, a communication unit 16 and such like.

The control unit 11 includes a CPU (Central Processing Unit) which performs predetermined arithmetic processing and controls the units by executing various programs stored in the storage unit 13 and a memory which is a working area when executing the programs (both of the CPU and the memory are not shown in the drawings). The control unit 11 executes various types of processing in cooperation with the programs stored in a program storage unit 131 of the storage unit 13.

The operation unit 12 includes a plurality of function buttons, detects a pressing signal of a function button and outputs the detected signal to the control unit 11.

The storage unit 13 is configured by including an HDD (Hard Disk Drive), a nonvolatile semiconductor memory or the like. As shown in FIG. 1, the storage unit 13 is provided with the program storage unit 131 and a content storage unit 132.

The program storage unit 131 stores system programs and various types of processing programs executed by the control unit 11, data necessary for executing the programs and such like.

The content storage unit 132 stores, as content data, moving image data and sound data so as to be associated with each other. The moving image data is data which was acquired by moving image photographing in the photographing unit 14. The sound data is a plurality of pieces of sound data which was acquired at positions in a plurality of height directions in synchronization with the moving image photographing in the sound acquisition unit 15 and each of which is accompanied with height information on the height when the sound data was acquired. Here, the sound not only indicates person's voice but also widely includes general sounds such as music and natural sounds.

The photographing unit 14 is a camera capable of moving image photographing in 360 degrees (omnidirectionally), and acquires moving image data in 360 degrees in response to an instruction from the control unit 11.

The sound acquisition unit 15 includes a plurality of microphones and acquires sound data at positions in a plurality of height directions in response to the instruction from the control unit 11. In the embodiment, the sound acquisition unit 15 is configured by including a microphone 151 which is attached to the head of a photographer M, a microphone 152 which is attached to the waist and a microphone 153 which is attached to the knee (see FIG. 6), and the sound acquisition unit 15 acquires sound data at the positions in the three height directions.

The communication unit 16 is configured by including a modem, a router, a network card and such like, and communicates with external equipment such as the content output device 2 which is connected to the communication network N.

### [Configuration of Content Output Device 2]

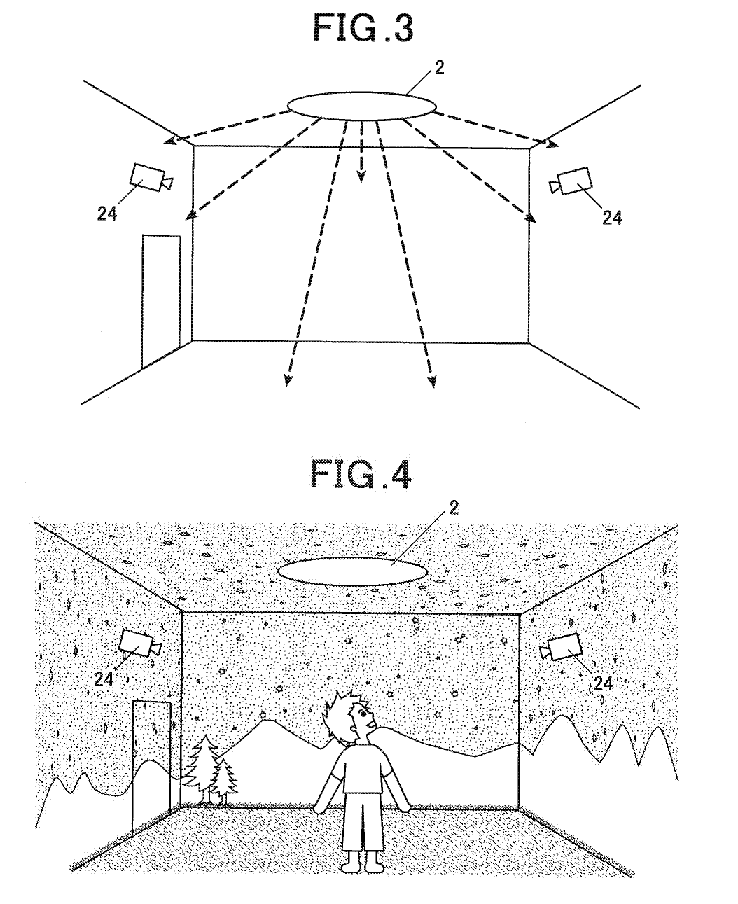

The content output device 2 is provided, for example, on a ceiling in a room as shown in FIG. 3. The content output device 2 outputs (projects) the contents omnidirectionally (whole area in 360 degrees) in the room as shown in FIG. 4.

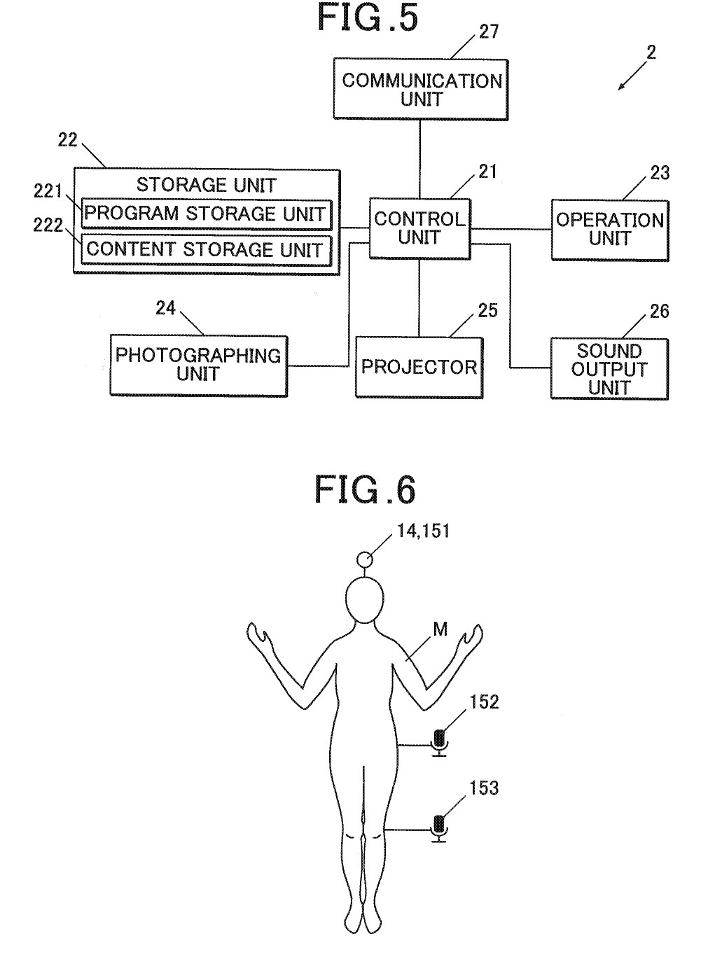

FIG. 5 is a block diagram showing the main control configuration of the content output device 2 in the embodiment. As shown in FIG. 5, the content output device 2 is configured by including a control unit 21, a storage unit 22, an operation unit 23, a photographing unit 24, a projector 25, a sound output unit 26, a communication unit 27 and such like.

The control unit 21 includes a CPU (Central Processing Unit) which performs predetermined arithmetic processing and controls the units by executing various programs stored in the storage unit 22 and a memory which is a working area when executing the programs (both of the CPU and the memory are not shown in the drawings). The control unit 21 executes after-mentioned output control processing in cooperation with the programs stored in a program storage unit 221 of the storage unit 22.

The storage unit 22 is configured by including an HDD (Hard Disk Drive), a nonvolatile semiconductor memory or the like. As shown in FIG. 5, the storage unit 22 is provided with the program storage unit 221 and a content storage unit 222.

The program storage unit 221 stores system programs and various types of processing programs executed by the control unit 21, data necessary for executing the programs and such like.

The content storage unit 222 stores the content data which was sent from the content storage device 1.

The operation unit 23 includes a plurality of function buttons, detects a pressing signal of a function button and outputs the detected signal to the control unit 21.

The photographing unit 24 includes a camera which includes an optical system and imaging elements, and a photographing control unit which controls the camera. The optical system of the camera is directed in a direction capable of photographing the viewer in the room and acquires a photographed image of the viewer.

The projector 25 includes fisheye lens, and omnidirectionally projects moving image data of the content output from the control unit 21.

The sound output unit 26 includes a D/A convertor, an amplifier, a speaker and such like. The sound output unit 26 converts the sound data into an analog signal by the D/A convertor in accordance with the instruction from the control unit 21, thereafter amplifies the analog sound signal to a predetermined sound volume by the amplifier and outputs the signal as sound from the speaker. The sound output unit 26 is a surround sound unit and capable of outputting sound from a plurality of directions.

The projector 25 and the sound output unit 26 function as an output unit.

The communication unit 27 is configured by including a modem, a router, a network card and such like, and communicates with external equipment such as the content storage device 1 which is connected to a communication network such as a LAN (Local Area Network) and a WAN (Wide Area Network).

### [Operation of Content Storage Device 1]

Next, the operation of the content storage device 1 in the embodiment will be described.

When moving image photographing is performed by using the content storage device 1, as shown in FIG. 6, the photographer M instructs to start the moving image photographing by the operation unit 12, with the photographing unit 14 and the microphone 151 attached to the head, the microphone 152 attached to the waist and the microphone 153 attached to the knee. The control unit 11 of the content storage device 1 executes the following processing in cooperation with the program stored in the program storage unit 131 according to the instruction by the operation unit 12.

When the start of moving image capturing is input by the operation unit 12, the control unit 11 of the content storage device 1 causes the photographing unit 14 to start the moving image photographing and causes the microphones 151 to 153 of the sound acquisition unit 15 to start acquisition of sound in synchronization with the timing of the start of moving image photographing. Thus, the sound data of sound which is output along with the moving image can be acquired at the positions in a plurality of height directions.

When the end of the moving image photographing is instructed by the operation unit 12, the control unit 11 stops the moving image photographing by the photographing unit 14 and the acquisition of sound data by the sound acquisition unit 15, and provides height information at the time of sound acquisition to the sound data which was acquired at the positions in the plurality of height directions by the microphones 151 to 153. In the embodiment, as the height information, the control unit 11 provides “head” to the sound data acquired by the microphone 151, “waist” to the sound data acquired by the microphone 152 and “knee” to the sound data acquired by the microphone 153, for example. The sound data is a predetermined sound file format, for example, and the control unit 11 writes the height information to the metadata. The control unit 11 stores, as content data, the moving image data acquired by the moving image photographing and the plurality of pieces of sound data acquired at the positions in the plurality of height directions in the storage unit 13 so as to be associated with each other.

When the content data stored in the content storage unit 132 is selected by the operation unit 12 and transmission to the content output device 2 is instructed, the control unit 11 transmits the selected content data to the content output device 2 by the communication unit 16.

In the content output device 2, the content data from the content storage device 1 is received by the communication unit 27, the control unit 21 stores the received content data in the content storage unit 222.

### [Operation of Content Output Device 2]

Next, the operation of the content output device 2 in the embodiment will be described.

When the content is selected by the operation unit 23 and output of the content is instructed, the control unit 21 starts output of the selected content by the projector 25 and the sound output unit 26. That is, the control unit 21 reads the content data of the selected content from the content storage unit 222, converts the moving image data of the read content data into projection data for omnidirectional projection, and causes the projector 25 to project the moving image of the content omnidirectionally. The control unit 21 causes the sound output unit 26 to output sound of the content on the basis of the sound data of the read content data. When starting the output of content, the control unit 21 causes the sound output unit 26 to output the sound on the basis of sound data in a predetermined height direction, for example, the sound data corresponding to the height information of the “waist”.

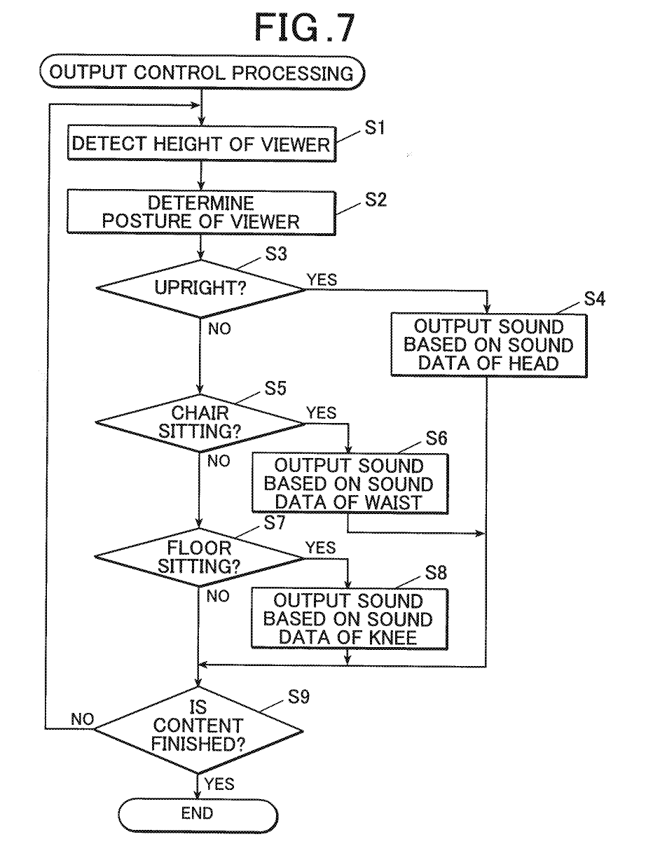

When output of the content is started, the control unit 21 executes output control processing shown in FIG. 7. The output control processing is executed in cooperation between the control unit 21 and the program stored in the program storage unit 221.

In the output control processing, the control unit 21 first acquires the height of a viewer watching the content (step S1).

For example, the control unit 21 causes the photographing unit 24 to perform photographing, recognizes the face of the viewer from the photographed image acquired by the photographing, and detects the height H of the viewer on the basis of the height of the recognized face in the photographed image.

Next, the control unit 21 determines the posture of the viewer on the basis of the height of the viewer (step S2). For example, the control unit 21 determines that the viewer is in an upright position in a case of H>threshold T1, determines that the viewer is in a chair sitting position in a case of threshold T1≥H>threshold T2, and determines that the viewer is in a floor sitting position in a case of threshold T2≥H (T1>T2).

If the control unit 21 determines that the viewer is in the upright position (step S3: YES), the control unit 21 causes the sound output unit 26 to output sound of the moving image on the basis of the sound data which was acquired at the position of the head (step S4), and proceeds to step S9.

If the control unit 21 determines that the viewer is in the chair sitting position (step S3: NO, step S5: YES), the control unit 21 causes the sound output unit 26 to output sound of the moving image on the basis of the sound data acquired at the position of the waist (step S6), and proceeds to step S9.

If the control unit 21 determines that the viewer is in the floor sitting position (step S3: NO, step S5: NO and step S7: YES), the control unit 21 causes the sound output unit 26 to output sound of the moving image on the basis of the sound data acquired at the position of the knee (step S8), and proceeds to step S9.

If the control unit 21 does not determine that the viewer is in the floor sitting position (step S3: NO, step S5: NO and step S7: NO), the control unit 21 proceeds to step S9. Here, the case of NO in step S7 is, for example, a case where the face recognition in the photographed image failed (such as a case where no person exists).

In step S9, the control unit 21 determines whether the content is finished (step S9). If the control unit 21 does not determine that the content is finished (step S9: NO), the control unit 21 returns to step S1, and repeatedly executes the steps S1 to S9.

If the control unit 21 determines that the content is finished (step S9: YES), the control unit 21 ends the output control processing.

As described above, according to the content output device 2, the control unit 21 causes the photographing unit 24 to photograph the viewer, detects the height of the viewer watching the content on the basis of the acquired photographed image, and causes the sound output unit 26 to output the sound of the content corresponding to the detected height.

Accordingly, it is possible to output sound with realistic sensation corresponding to the height of the viewer.

For example, the content has a plurality of pieces of sound acquired at the positions in the plurality of height directions, and the control unit 21 causes the sound output unit 26 to output sound acquired at the position corresponding to the detected height among the plurality of pieces of sound. Thus, it is possible to output sound corresponding to the height of the viewer.

For example, the control unit 21 determines the posture of the viewer on the basis of the detected height of the viewer, and causes the sound output unit 26 to output sound acquired at the position in the height direction corresponding to the posture of the viewer. Thus, for example, when the viewer changes the posture from the upright position to the sitting position, it is possible to output sound which was acquired at a low position and output the sound with realistic sensation corresponding to the posture of the viewer.

The content is a moving image which is output omnidirectionally, and the sound corresponding to the height of the viewer is output along with the moving image. Thus, it is possible to output the content with realistic sensation.

According to the content storage device 1, the sound output along with the moving image of the content is acquired at positions in a plurality of height directions, height information at the time of sound acquisition is provided to each piece of sound data of the plurality of pieces of the acquired sound, and the sound data is associated with the moving image data of the moving image and stored as content data in the content storage unit 132. Accordingly, in the content output device 2, it is possible to acquire and store content data for which sound corresponding to the height of the viewer can be output.

In the content data, moving image data and a plurality of pieces of sound data are associated with each other. The sound data is a plurality of pieces of sound data which was acquired by acquiring the sound output along with a moving image based on the moving image data at positions in a plurality of height directions, and the height information at the time of sound acquisition is provided to each of the plurality of pieces of sound data. Accordingly, in the content output device 2, it is possible to output the sound of the content corresponding to the height of the viewer.

The description in the above embodiment is an example of the content storage device and the content output device according to the present invention, and the present invention is not limited to this.

For example, in the embodiment, sound data is acquired at positions in a plurality of height directions by attaching microphones to the head, waist and knee of the photographer M, and the distinctions of “head”, “waist” and “knee” are provided as the height information. However, the present invention is not limited to this. For example, an air pressure sensor or the like may be provided to each of the microphones 151 to 153 so that the height of each microphone is measured at the start of the moving image photographing or the like, and the measurement value is provided as the height information to the sound data which was acquired at each microphone. The sound data of the sound to be output may be determined from among the plurality of pieces of sound data on the basis of the height of the viewer watching the content and the height information provided to each piece of the sound data.

In the embodiment, the content output device 2 includes an output control device including a detection unit and a control unit of the present invention and an output unit (projector 25, and sound output unit 26) which outputs the content. However, they may be separate devices which are connected via the communication network, for example.

The embodiment has been described by taking, as an example, a case where the content output device projects the image of the content by using the projector. However, there may be used a VR (Virtual Reality) head-mounted display.

In this case, for example, an air pressure sensor may be provided to the VR head-mounted display so that the height of the viewer wearing the VR head-mounted display is detected by using the air pressure sensor, any piece of the sound data in a plurality of height directions is selected on the basis of the result of comparison between the detected height and a predetermined threshold, and sound is output on the basis of the selected sound data. Thereby, even in the VR head-mounted display, it is possible to output sound with realistic sensation corresponding to the movement and posture in the height direction of the viewer. The sensor for detecting the height is not limited to the air pressure sensor, and the height may be detected by a method of detecting the change in height direction with an acceleration sensor, for example.

The other detail configurations and detailed operations of the devices forming the content output system can also be appropriately changed within the scope of the present invention.

Though several embodiments of the present invention have been described above, the scope of the present invention is not limited to the above embodiments, and includes the scope of inventions, which is described in the scope of claims, and the scope equivalent thereof.

What is claimed is:

1. An output control device comprising a hardware processor, wherein the hardware processor is configured to:
acquire a height of a viewer who watches a content; and
cause an output unit to output a sound of the content corresponding to the acquired height.

2. The output control device according to claim 1, wherein
the content has a plurality of sounds which is acquired at positions in a plurality of height directions, and
the hardware processor causes the output unit to output a sound which is acquired at a position corresponding to the acquired height among the plurality of sounds.

3. The output control device according to claim 2, wherein the hardware processor determines a posture of the viewer based on the acquired height, and causes the output unit to output a sound which is acquired at a position corresponding to the determined posture of the viewer.

4. The output control device according to claim 3, wherein the posture of the viewer is an upright position, a chair sitting position or a floor sitting position.

5. The output control device according to claim 1 further comprising a memory, wherein
the hardware processor selects sound data corresponding to the acquired height from among a plurality of pieces of sound data which is included in the content,
the hardware processor controls the output unit to output a sound based on the selected sound data, and
a moving image and the plurality of pieces of sound data included in the content are stored in the memory.

6. The output control device according to claim 1, wherein the content is a moving image which is output omnidirectionally, and the sound includes a sound which is output along with the moving image.

7. The output control device according to claim 6, wherein
the hardware processor selects sound data corresponding to the acquired height from among a plurality of pieces of sound data which is stored so as to be associated with the moving image,
the hardware processor controls the output unit to output both of the moving image and a sound based on the selected sound data, and
the moving image and the plurality of pieces of sound data are stored in the memory.

8. The output control device according to claim 1, wherein
the hardware processor acquires second height information of the viewer after the hardware processor causes the output unit to output the sound of the content corresponding to the acquired height, and
the hardware processor causes the output unit to output a sound of the content based on the acquired second height information.

9. The output control device according to claim 3, wherein
the hardware processor acquires second height information of the viewer after the hardware processor causes the output unit to output the sound of the content corresponding to the acquired height, and
the hardware processor causes the output unit to output a sound of the content based on the acquired second height information.

10. The output control device according to claim 6, wherein
the hardware processor acquires second height information of the viewer after the hardware processor causes the output unit to output the sound of the content corresponding to the acquired height, and
the hardware processor causes the output unit to output a sound of the content based on the acquired second height information.

11. The output control device according to claim 1 further comprising a memory,
wherein the hardware processor acquires a height of a viewer who watches a content from the memory.

12. A content storage device, comprising:
a memory; and
a hardware processor, wherein
the hardware processor executes:
sound acquisition processing of acquiring a sound which is output along with a moving image included in a content at positions in a plurality of height directions; and
storage processing of providing height information on a height when the sound is acquired to each of a plurality of pieces of sound data of the sound which is acquired by the sound acquisition processing, and storing the plurality of pieces of sound data in the memory so as to be associated with moving image data of the moving image.

13. An output control method, comprising:
acquiring a height of a viewer who watches a content; and
causing an output unit to output a sound of the content corresponding to the acquired height.

14. The output control method according to claim 13, further comprising causing the output unit to output a sound which is acquired at a position corresponding to the acquired height among a plurality of sounds, wherein the content has the plurality of sounds which is acquired at positions in a plurality of height directions.

15. The output control method according to claim 14, further comprising:
determining a posture of the viewer based on the acquired height, and
causing the output unit to output a sound which is acquired at a position corresponding to the determined posture of the viewer.

16. A non-transitory storage medium encoded with a computer readable program that enables a computer to execute functions comprising:
acquisition processing of acquiring a height of a viewer who watches a content; and
control processing of causing an output unit to output a sound of the content corresponding to the height which is acquired by the acquisition processing.

17. The storage medium according to claim 16, wherein
the content has a plurality of sounds which is acquired at positions in a plurality of height directions, and
the program causes the computer to execute output processing of causing the output unit to output a sound which is acquired at a position corresponding to the acquired height among the plurality of sounds.

18. The storage medium according to claim 17, wherein the program causes the computer to execute:
determination processing of determining a posture of the viewer based on the acquired height, and
output processing of causing the output unit to output a sound which is acquired at a position corresponding to the determined posture of the viewer.
